(19) United States
(12) Patent Application Publication
(10) Pub. No.: US 2022/0391501 A1
(43) Pub. Date: Dec. 8, 2022

(54) LEARNING APPARATUS, DETECTION APPARATUS, LEARNING METHOD AND ANOMALY DETECTION METHOD

(71) Applicant: Nippon Telegraph and Telephone Corporation, Tokyo (JP)

(72) Inventors: Kengo TAJIRI, Musashino-shi, Tokyo (JP); Keishiro Watanabe, Musashino-shi, Tokyo (JP)

(21) Appl. No.: 17/775,333

(22) PCT Filed: Nov. 11, 2019
(86) PCT No.: PCT/JP2019/044165

§ 371 Date: May 9, 2022

(51) Int. Cl. G06F 21/55

(52) U.S. Cl. CPC G06F 21/554; G06F 2221/034

(57) ABSTRACT

Disclosed is a learning device including: a pseudo data generation determination unit that determines whether generation of pseudo data is needed to learn an abnormality detection model on a basis of a plurality of data having category information; a pseudo data generation unit that generates pseudo data of a category when generation of the pseudo data of the category is determined to be needed by the pseudo data generation determination unit; and an abnormality detection model learning unit that learns the abnormality detection model using the plurality of data and the pseudo data generated by the pseudo data generation unit.

### TECHNICAL FIELD

The present invention relates to a technology to detect the abnormality of data using a machine learning method.

### BACKGROUND ART

In recent years, technologies to perform abnormality detection for network data such as flow data using machine learning methods have been discussed.

For example, a case in which abnormality detection for flow data is performed to detect network intrusion will be considered. For example, data obtained by extracting feature amounts from data collected by tcpdump is used. On this occasion, the feature amounts can be roughly categorized into following two types.

One type is a flow length or the like that is expressed by a real number. The other type is category information such as tcp and udp. Hereinafter, data having a feature amount of category information as described above will be defined as multiclass data. In the case of a flow example, data belonging to a tcp class and data belonging to a udp class are examples of multiclass data. In multiclass data, the number of data for each class is greatly different in some cases. Note that a “class” may be called a “category”.

Abnormality detection methods using machine learning are roughly categorized into a supervised learning method and an unsupervised learning method. According to the supervised learning method, categorization into the two types of normality and abnormality is performed. According to the unsupervised learning method, only normal data is learned, an abnormality degree is calculated from the deviation of output data from the normal data, and normality or abnormality is determined on the basis of a threshold.

### CITATION LIST

### Non Patent Literature

[NPL 1] S. K. Lim et al., “Doping: Generative data augmentation for unsupervised anomaly detection with GAN”, 2018 IEEE International Conference on Data Mining, 1122-1127, 2018.

### SUMMARY OF THE INVENTION

### Technical Problem

If there is a large difference in the number of data belonging to respective categories when abnormality detection by unsupervised machine learning is performed on data having category information not relevant to normality and abnormality, there is a problem that abnormality detection accuracy could reduce.

That is, since rare data is often determined to be abnormal in the unsupervised learning, there is a possibility that data belonging to a category that is normal but rare is determined to be abnormal (the possibility of false detection due to a false positive determination). As a result, there is a possibility that abnormality detection accuracy reduces.

The present invention has been made in view of the above point and has an object of providing a technology to prevent a reduction in abnormality detection accuracy even when there is a large difference in the number of data between categories in abnormality detection in which the number of the data is different between the categories.

### Means for Solving the Problem

According to a disclosed technology, there is provided a learning device including:

a pseudo data generation determination unit that determines whether generation of pseudo data is needed to learn an abnormality detection model on a basis of a plurality of data having category information;

a pseudo data generation unit that generates pseudo data of a category when generation of the pseudo data of the category is determined to be needed by the pseudo data generation determination unit; and

an abnormality detection model learning unit that learns the abnormality detection model using the plurality of data and the pseudo data generated by the pseudo data generation unit.

### Effects of the Invention

According to a disclosed technology, there is provided a technology to prevent a reduction in abnormality detection accuracy even when there is a large difference in the number of data between categories in abnormality detection in which the number of the data is different between the categories.

### BRIEF DESCRIPTION OF DRAWINGS

FIG. 1 is a configuration diagram of an abnormality detection device in an embodiment of the present invention.

FIG. 2 is a diagram showing a hardware configuration example of a device.

FIG. 3 is a flowchart for describing the operation of the abnormality detection device.

FIG. 4 is a diagram for describing numeric vectorization processing.

FIG. 5 is a diagram showing the outline of the model of Conditional VAE.

FIG. 6 is a diagram showing the outline of the model of Conditional GAN.

FIG. 7 is a diagram showing the outline of the model of AC-GAN.

FIG. 8 is a diagram showing experimental results.

### DESCRIPTION OF EMBODIMENTS

Hereinafter, an embodiment of the present invention will be described with reference to the drawings. The embodiment described below shows only an example, and an embodiment to which the present invention is applied is not limited to the following embodiment.

(Device Configuration)

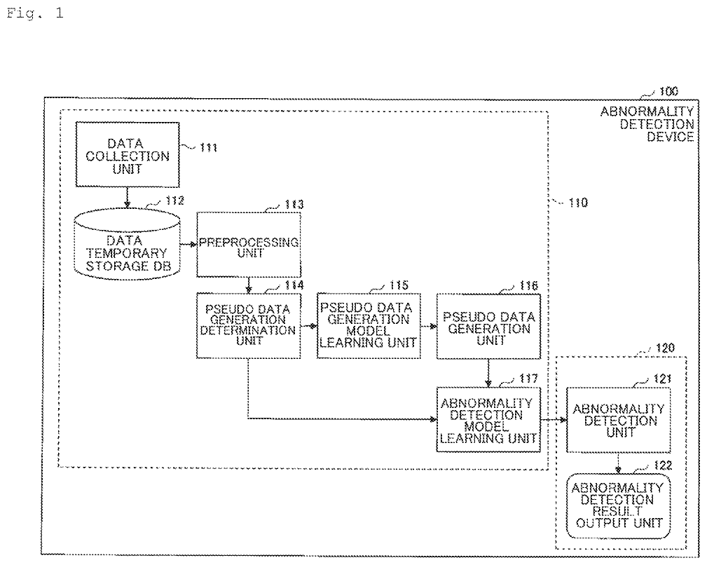

FIG. 1 shows a function configuration diagram of an abnormality detection device 100 in the embodiment of the present invention. As shown in FIG. 1, the abnormality detection device 100 has a data collection unit 111, a data temporary storage DB (database) 112, a preprocessing unit 113, a pseudo data generation determination unit 114, a pseudo data generation model learning unit 115, a pseudo data generation unit 116, an abnormality detection model learning unit 117, an abnormality detection unit 121, and an abnormality detection result output unit 122. The operations of the respective units will be described in detail in the section of an operation example of the abnormality detection device 100 that will be described later. Note that “learning” may be replaced by “training” in the present specification.

The abnormality detection device 100 may be physically constituted by one device (computer) or a plurality of devices (computers). Further, even where the abnormality detection device 100 is constituted by one device or a plurality of devices, the abnormality detection device 100 may be realized by a virtual machine on a cloud.

The abnormality detection device 100 performs abnormality detection, while learning a model. Therefore, the abnormality detection device 100 may be called a learning device or a detection device.

Further, when it is assumed that a portion (including the data collection unit 111, the data temporary storage DB 112, the preprocessing unit 113, the pseudo data generation determination unit 114, the pseudo data generation model learning unit 115, the pseudo data generation unit 116, and the abnormality detection model learning unit 117) shown by dashed lines 110 is a learning device 110 and a portion (including the abnormality detection unit 121 and the abnormality detection result output unit 122) shown by dashed lines 120 is a detection device 120 in FIG. 1, the abnormality detection device 100 may include the separate devices.

When the abnormality detection device 100 includes the learning device 110 and the detection device 120, an abnormality detection model (specifically, optimized parameters or the like) learned by the learning device 110 is input to the abnormality detection unit 121 of the detection device 120 and stored in a storage unit or the like such as a memory in the abnormality detection unit 121. The abnormality detection unit 121 inputs data (data of an abnormality detection target) input from an outside to an abnormality detection model and performs abnormality detection on the basis of data output from the abnormality detection model.

### Hardware Configuration Example

Any of the abnormality detection device 100, the learning device 110, and the detection device 120 (hereinafter collectively called the device) can be realized by running a program describing processing contents described in the present embodiment. Note that this “computer” may be a physical machine or a virtual machine. When a virtual machine is used, hardware described here is virtual hardware.

It is possible to realize the device by running a program corresponding to processing performed in the device with a hardware resource such as a CPU and a memory included in the computer. It is possible to preserve or distribute the above program after recording the same on a computer-readable recording medium (such as a portable memory). Further, it is also possible to provide the above program via a network such as the Internet and an e-mail.

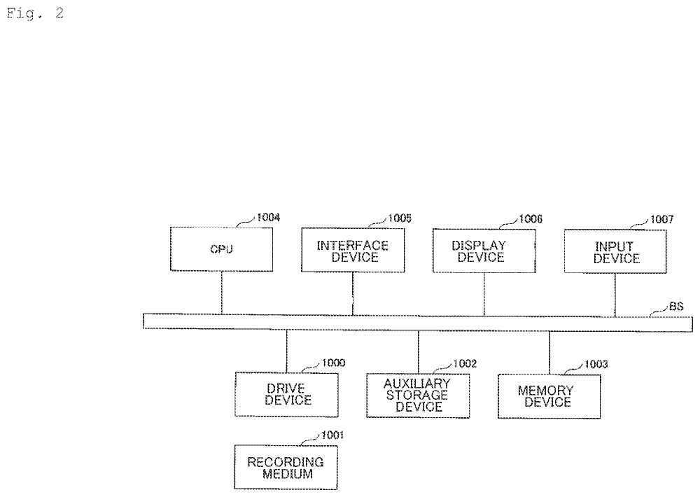

FIG. 2 is a diagram showing a hardware configuration example of the above computer. The computer of FIG. 2 has a drive device 1000, an auxiliary storage device 1002, a memory device 1003, a CPU 1004, an interface device 1005, a display device 1006, an input device 1007, and the like, all of which are connected to each other via a bus B.

A program for realizing processing in the computer is provided by a recording medium 1001 such as a CD-ROM and a memory card. When the recording medium 1001 storing the program is set in the drive device 1000, the program is installed in the auxiliary storage device 1002 via the drive device 1000 from the recording medium 1001. However, the program is not necessarily installed from the recording medium 1001 but may be downloaded from other computers via a network. The auxiliary storage device 1002 stores necessary files, data, or the like, while storing the installed program.

The memory device 1003 reads a program from the auxiliary storage device 1002 and stores the read program when receiving an instruction to start the program. The CPU 1004 realizes functions relating to the device according to the program stored in the memory device 1003. The interface device 1005 is used as an interface for network connection. The display device 1006 displays a GUI (Graphical User Interface) or the like based on the program. The input device 1007 is constituted by a keyboard, a mouse, a button, a touch panel, or the like and used to input various operation instructions.

(Operation Example of Abnormality Detection Device 100)

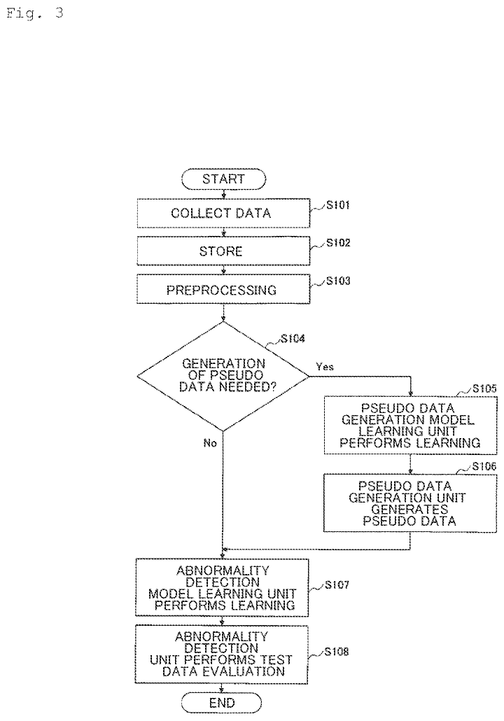

An operation example of the abnormality detection device 100 will be described along a procedure shown in the flowchart of FIG. 3.

<S101 and S102: Data Collection and Storage>

In S101, the data collection unit 111 collects data having category information that serves as an abnormality detection target from a network or the like to which the abnormality detection device 100 is connected, and stores the collected data in the data temporary storage DB 112. The data having the category information is, for example, flow data.

<S103: Preprocessing>

In S103, the preprocessing unit 113 reads data from the data temporary storage DB 112 and performs processing to deform the read data into the shape of a numeric vector for machine learning as preprocessing. That is, data input to a model is a numeric vector.

More specifically, for example, the preprocessing unit 113 performs processing to extract feature amounts from collected data and arrange numeric data (such as duration in the case of flow data) existing in one data in a line to make a numeric vector or perform processing to make category data into a one-hot vector as the preprocessing.

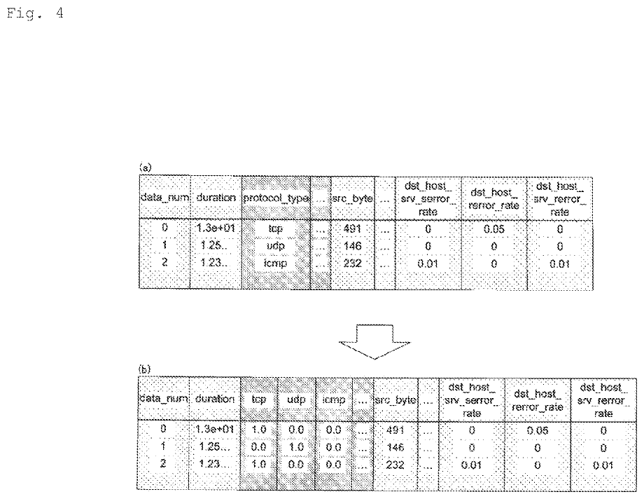

FIG. 4 shows an example of the preprocessing. FIG. 4(a) shows a state in which feature amounts extracted from collected data are arranged side by side to make a vectorization. In FIG. 4(a) (and FIG. 4(b)), finely-hatched portions show category data, and coarsely-hatched portions show real number data.

FIG. 4(b) shows a state in which a column (element) is provided for each category with respect to category data (specifically, a protocol type) shown in FIG. 4(a) and the value of the column (element) is set at 1 when the column corresponds to a certain category and the value of the column (element) is set at 0 when the column does not correspond to the category for each data. That is, processing to make a one-hot vector is shown.

<S104: Pseudo Data Generation Determination>

In S104, the pseudo data generation determination unit 114 makes a determination as to whether the generation of pseudo data is needed for data having been subjected to the preprocessing. More specifically, the determination is made as follows.

The pseudo data generation determination unit 114 first calculates the number of data to be used for learning for each category with respect to the data (for example, FIG. 4 (b)) made into a numeric vector and finds out a difference in the number of the data between the categories.

In the case of data retaining a plurality of category data such as protocol categories (tcp, udp, and icmp) and service categories (such as http and ftp) in flow data, the pseudo data generation determination unit 114 calculates the number of data for each combination such as a combination of (a protocol category and a service category). Note that such a combination may also be called a “category”.

In this case, the pseudo data generation determination unit 114 calculates, for example, the number of data for each combination such as the number of data of a combination of (tcp and http), the number of data of a combination of (tcp and ftp), the number of data of a combination of (udp and http), and the number of data of a combination of (udp and ftp).

Further, the pseudo data generation determination unit 114 may independently calculate the number of data for each individual type (category) with respect to respective categories such as for each protocol category and for each service category. In this case, the pseudo data generation determination unit 114 calculates the number of data for each category such as the number of data of tcp and the number of data of udp.

In the pseudo data generation determination unit 114, a threshold for determining whether to generate pseudo data is stored in advance in a storage unit such as a memory. Further, in the pseudo data generation determination unit 114, the number of data generated when pseudo data is generated or a constant such as the ratio of a category having the maximum number of data to the number of data is also stored in advance.

Then, for example, the pseudo data generation determination unit 114 makes a determination under a rule such as “when the number of data of a category is one-tenth or less of category data having the maximum number of data, the pseudo data of the category is generated by a generation model until the number of the data of the category becomes 50% of the number of the maximum data”.

As an example, when the protocol categories (tcp, udp, and icmp) are used in making a determination in a state in which the above rule is set in the pseudo data generation determination unit 114, it is assumed that, for example, the number of data of udp is 10,000 at maximum in the protocol categories (tcp, udp, and icmp), the number of data of tcp is 900, and the number of data of icmp is 500.

In this case, since “the number of data is one-tenth or less of category data having the maximum number of data” for each of the data of tcp and the data of icmp, pseudo data is generated by 5,000 for each of the data of tcp and the data of icmp. Information on the type of a category and the number of pseudo data to be generated is delivered from the pseudo data generation determination unit 114 to the pseudo data generation unit 116. Note that the number of pseudo data to be generated may be determined by a function unit (for example, the pseudo data generation unit 116) other than the pseudo data generation determination unit 114.

When the determination in S104 of the flow of FIG. 3 is Yes (the generation of pseudo data is needed), the flow of FIG. 3 proceeds to S105.

<S105: Learning of Pseudo Data Generation Model>

In S105, the pseudo data generation model learning unit 115 learns a pseudo data generation model to generate data (pseudo data) belonging to a category to be generated.

A pseudo data generation model used in the present embodiment is a model that generates data belonging to a specific category using category information. The model is not limited to a specific model. As the model, Conditional VAE (reference 3), Conditional GAN (reference 4), AC-GAN (reference 5), or the like can be, for example, used. These models are models that generate data belonging to a specific category using category information among the derivations of Variational Autoencoder (VAE) (reference 1) and Generative Adversarial Networks (GAN) (reference 2) that are data generation technologies. Note that the names of the respective references will be described in the last of the embodiment.

The pseudo data generation model learning unit 115 learns a model by assigning category information. The learned pseudo data generation model (specifically, optimized parameters or the like) is delivered to the pseudo data generation unit 116.

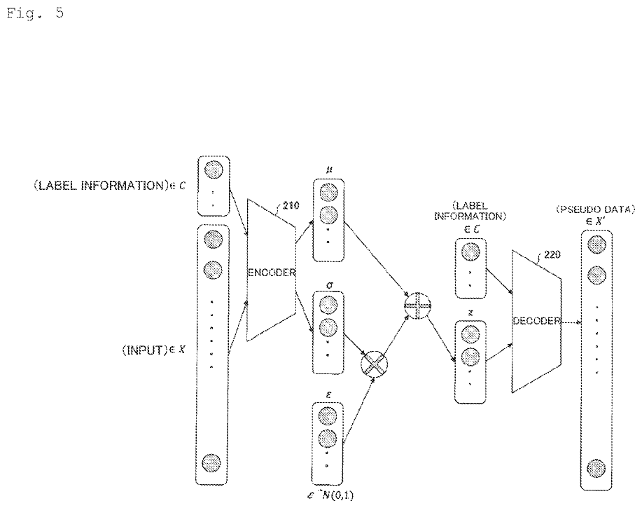

Examples of the models learned by the pseudo data generation model learning unit 115 are shown in FIGS. 5, 6 and 7. Note that the models themselves shown in FIGS. 5, 6 and 7 are existing technologies.

FIG. 5 shows the model of Conditional VAE. In learning, label information (category information) and the actual data of the category are input to an encoder 210, and a latent variable z is output. The label information and the latent variable z are input to a decoder 220 and output data and the input data to the encoder 210 are compared with each other, whereby the respective parameters of the encoder 210 and the decoder 220 are adjusted so that output data close to the input data to a greater extent is obtained.

Note that in the learning of a pseudo data generation model, a category and data used to be input are not limited to the categories of pseudo data generation targets but other categories and their data are also used to be input.

In generating pseudo data that will be described later, the pseudo data generation unit 116 inputs the label information (category information specified by the pseudo data generation determination unit 114) and the latent variable z to the learned decoder 220 to obtain the pseudo data of a target category.

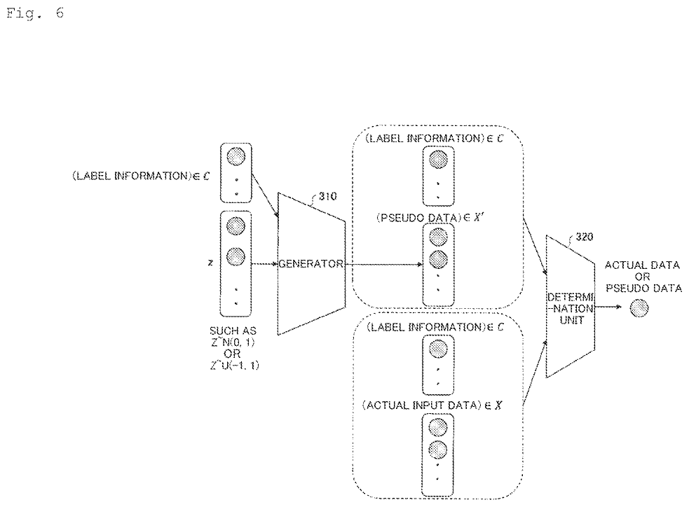

FIG. 6 shows the model of Conditional GAN. In learning, label information (category information) and a latent variable z (multidimensional noise) are input to a generator 310, and pseudo data is output. The label information and pseudo data and the label information and actual data are alternately input to a determination unit 320. The determination unit 320 determines whether the input data is the actual data (real one) or the pseudo data (false one).

The parameters of the generator 310 and the determination unit 320 are adjusted on the basis of a determination result (as to whether a determination is correct), whereby the generator 310 outputs pseudo data close to a real one to a greater extent.

In generating pseudo data, the pseudo data generation unit 116 inputs the label information (category information specified by the pseudo data generation determination unit 114) and the latent variable z to the learned generator 310 to obtain the pseudo data of a target category.

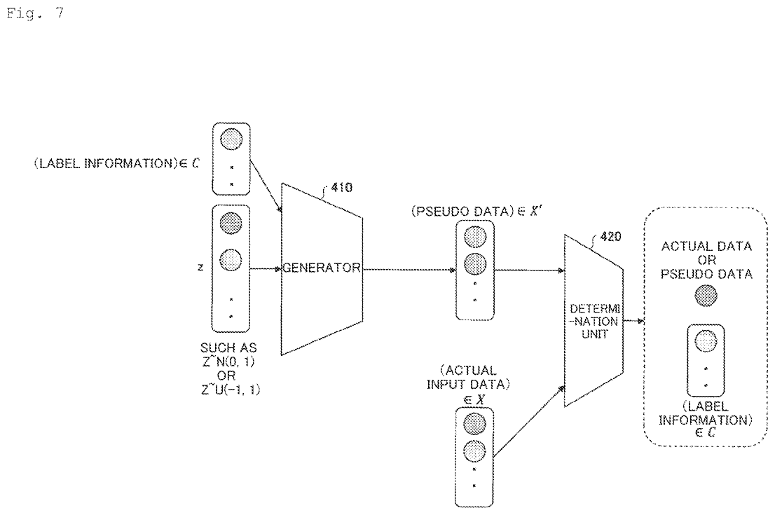

FIG. 7 shows the model of AC-GAN. In learning, label information (category information) and a latent variable z (multidimensional noise) are input to a generator 410, and pseudo data is output. Pseudo data and actual data are alternately input to a determination unit 420. The determination unit 320 determines whether the input data is the actual data (real one) or the pseudo data (false one).

The parameters of the generator 410 and the determination unit 420 are adjusted on the basis of a determination result (as to whether a determination is correct), whereby the generator 410 outputs pseudo data close to a real one to a greater extent.

In generating pseudo data, the pseudo data generation unit 116 inputs the label information (category information specified by the pseudo data generation determination unit 114) and the latent variable z to the learned generator 410 to obtain the pseudo data of a target category.

<S106: Generation of Pseudo Data>

In S106, the pseudo data generation unit 116 generates, using the learned pseudo data generation model, pseudo data on the basis of the conditions (such as the category of generated pseudo data and the number of generated pseudo data) determined by the pseudo data generation determination unit 114.

Specifically, the pseudo data generation unit 116 inputs the category of data to be generated and a numeric vector z (latent variable z) of a latent variable space to the pseudo data generation model and obtains an output from the pseudo data generation model as pseudo data.

Here, in the case of, for example, Conditional VAE, the pseudo data generation unit 116 can use, as z that serves as an input, z sampled from a probability distribution obtained by selecting any data used in learning and encoding the same with the encoder 210. Alternatively, the pseudo data generation unit 116 can use, as z that serves as an input, z sampled from a probability distribution defined by parameters obtained by averaging the parameters (an average and a variance in the case of a Gaussian distribution) of a probability distribution with respect to all data, or the like. In the case of Conditional GAN or AC-GAN, the pseudo data generation unit 116 generally uses, as z that serves as an input, z sampled from an appropriate probability distribution. As a probability distribution, a standard normal distribution, a uniform distribution [−1, 1], or the like is particularly used.

<S107: Learning of Abnormality Detection Model>

After S106 or in S107 to which the flow of FIG. 3 proceeds when a determination result is No (the generation of pseudo data is not needed) in S104, the abnormality detection model learning unit 117 learns an abnormality detection model.

In the present embodiment, it is presumed that an abnormality detection model is learned by unsupervised learning using only normal data. Therefore, a model disclosed in Isolation Forest (reference 6), a model disclosed in one class SVM (reference 7), a model disclosed in Autoencoder (AE) (reference 8), or the like can be used as an abnormality detection model.

As an example, a model is learned so that data input to the model (data collected in a period in which a system normally operates) and data output from the model come close to each other in the case of Autoencoder (AE). In testing (abnormality detection), data is input to a learned model, and the distance between input data and output data is output as an abnormality degree. For example, abnormality is detected if the abnormality degree exceeds a threshold.

In any abnormality detection model, actual data preprocessed by the preprocessing unit 113 and pseudo data generated by the pseudo data generation unit 116 are mixed together and input to the abnormality detection model to perform learning when the pseudo data is generated.

The learned abnormality detection model is delivered to the abnormality detection unit 121. The abnormality detection unit 121 stores the learned abnormality detection model.

<S108: Implementation of Abnormality Detection>

In S108, the abnormality detection unit 121 inputs data (data of an abnormality detection target) that is to be determined to be normal or abnormal to the learned abnormality detection model and calculates an abnormality degree from output data and input data from the learned abnormality detection model. The abnormality detection unit 121 compares a threshold for an abnormality degree arbitrarily determined in advance with an abnormality degree to determine the normality and abnormality of respective data. An abnormality detection result is delivered to the abnormality detection result output unit 122.

The abnormality detection result output unit 122 outputs an alert, for example, when receiving the abnormality of the data from the abnormality detection unit 121. The abnormality detection result output unit 122 may display the detection result (normality or abnormality) delivered from the abnormality detection unit 121. Further, the abnormality detection result output unit 122 transmits the detection result (normality or abnormality) delivered from the abnormality detection unit 121 to a monitoring system.

### Experimental Results

Using the abnormality detection device 100 according to the present embodiment, pseudo data corresponding to a category having a small number of data was generated in addition to actual data to perform abnormality detection. As a result, abnormality detection accuracy was improved. The abnormality detection was specifically performed as follows.

An experiment was conducted using the benchmark data of a network intrusion detection system called NSL-KDD. The two types of data of train data and test data exist in this data set, and each data includes normal data and abnormal data. In this experiment, only the normal data of the train data was used for the learning of both an abnormality detection model and a pseudo data generation model.

The three types of category data exist in the data of NSL-KDD. In this experiment, these category data items were handled as a combination. As a result, it was found that data having the category of a combination of (tcp and http) with respect to a combination of a protocol category and a service category accounts for 56% of the whole normal train data.

Therefore, in order to reduce the deviation of categories in the train data, a category that serves as a data generation target was generated from a uniform distribution, and pseudo data was generated using the category. The number of the normal data existing in the train data was 67,343, and 10,000 pseudo data was further generated. In this experiment, Conditional GAN was used to generate pseudo data.

Further, a case in which 10,000 pseudo data was generated as a comparison target using a general GAN was also evaluated. In the case of the general GAN, a category is not specified by a user, but the category itself is handled as a generation target level.

Using the two models of AE (abnormality detection model) learned only by 67,343 normal train data and AE learned by totally 77,343 data composed of the 67,343 train data and the 10,000 pseudo data, abnormality detection was performed on the two types of test data (Test+ and Test-21).

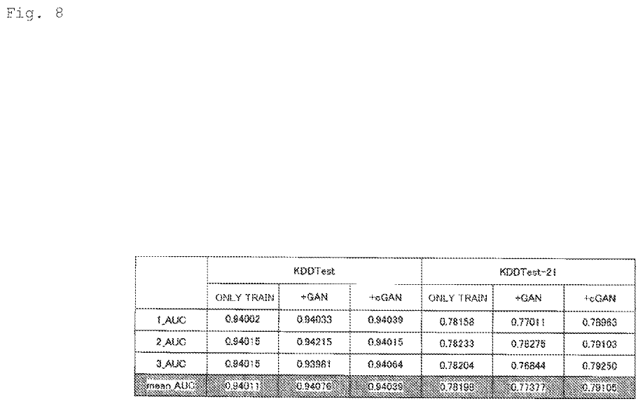

AUC representing accuracy obtained by performing the above abnormality detection was calculated. Calculation results are shown in FIG. 8. FIG. 8 shows experimental results (1_AUC, 2_AUC, and 3_AUC) of three times and means (mean_AUC) of the three times.

It is found from FIG. 8 that compared with a case (only Train) in which the AE was learned only by actual data and a case (+GAN) in which the AE was learned by pseudo data generated together with category information in GAN, abnormality detection accuracy was improved with an increase in AUC in a case (+cGAN) in which abnormality detection was performed by the AE learned together with pseudo data generated by the specification of a category in Conditional GAN. Particularly, it is found that the AUC of +cGAN is higher than those of other methods by about 0.01 in the abnormality detection of Test-21 in which only data difficult to read is gathered.

### Effect of Embodiment

As described above, the data of a category having a small amount of data is increased by a generation model that uses category information and used for the learning of abnormality detection in the present embodiment. Therefore, a reduction in abnormality detection resulting from a difference in the number of data between respective categories can be prevented with respect to abnormality detection for data having category information not directly linked to normality and abnormality, and abnormality detection accuracy can be improved.

### Summary of Embodiment

In the present specification, a learning device, a detection device, a learning method, and an abnormality detection method described in at least the following respective sections are described.

### (Section 1)

A learning device including:

a pseudo data generation determination unit that determines whether generation of pseudo data is needed to learn an abnormality detection model on a basis of a plurality of data having category information;

a pseudo data generation unit that generates pseudo data of a category when generation of the pseudo data of the category is determined to be needed by the pseudo data generation determination unit; and

an abnormality detection model learning unit that learns the abnormality detection model using the plurality of data and the pseudo data generated by the pseudo data generation unit.

### (Section 2)

The learning device according to section 1, wherein the pseudo data generation determination unit calculates the number of data for each category and determines whether generation of pseudo data is needed on a basis of a difference in the number of the data between the categories.

### (Section 3)

The learning device according to section 2, wherein the pseudo data generation unit generates pseudo data of a category for which generation of the pseudo data is determined to be needed to reduce the difference.

### (Section 4)

The learning device according to any one of sections 1 to 3, further including:

a pseudo data generation model learning unit that learns a generation model capable of generating data of a specified category.

### (Section 5)

A detection device including:

an abnormality detection unit that inputs data of an abnormality detection target to the abnormality detection model learned by the abnormality detection model learning unit in the learning device according to any one of sections 1 to 4 and performs abnormality detection on a basis of output data from the abnormality detection model.

### (Section 6)

A learning method performed by a learning device, the learning method including:

a pseudo data generation determination step of determining whether generation of pseudo data is needed to learn an abnormality detection model on a basis of a plurality of data having category information;

a pseudo data generation step of generating pseudo data of a category when generation of the pseudo data of the category is determined to be needed in the pseudo data generation determination step; and

an abnormality detection model learning step of learning the abnormality detection model using the plurality of data and the pseudo data generated in the pseudo data generation step.

### (Section 7)

An abnormality detection method performed by a detection device, the abnormality detection method including:

an abnormality detection step of inputting data of an abnormality detection target to the abnormality detection model learned by the learning method according to section 6 and performs abnormality detection on a basis of output data from the abnormality detection model; and

an output step of outputting a result of the abnormality detection.

The embodiment is described above. However, the present invention is not limited to the specific embodiment and may be deformed and modified in various ways within the scope of the gist of the present invention described in claims.

### REFERENCES

Reference 1: D. P. Kingma and M. Welling, “Auto-encoding variational Bayes”, International Conference on Learning Representation, 2014.
Reference 2: I. Goodfellow et al., “Generative adversarial nets”, Advances in neural information processing systems, 2672-2680, 2014.
Reference 3: D. P. Kingma et al., “Semi-supervised learning with deep generative models”, Advances in Neural Information Processing Systems, 2014.
Reference 4: M. Mirza and S. Osindero, “Conditional Generative Adversarial Nets”, arXiv:1411.1784, 2014.
Reference 5: A. Odena, C. Olah and J. Shlens, “Conditional Image Synthesis With Auxiliary Classifier GANs”, Conputer Vision and Pattern Recognition, 2016.
Reference 6: F. T. Liu, K. M. Ting and Zhi-Hua Zhou, “Isolation forest”, 2008 Eighth IEEE International Conference on Data Mining, 413-422, 2008.
Reference 7: L. M. Manevitz and M. Yousef, “One-class SVMs for document classification”, Journal of machine Learning research, 2, 139-154, 2001.
Reference 8: M. Sakurada and T. Yairi, “Anomaly detection using autoencoders with nonlinear dimensionality reduction”, Proceedings of the MLSDA 2014 2nd Workshop on Machine Learning for Sensory Data Analysis, 2014.

### REFERENCE SIGNS LIST

100 Abnormality detection device
111 Data collection unit
112 Data temporary storage DB
113 Preprocessing unit
114 Pseudo data generation determination unit
115 Pseudo data generation model learning unit
116 Pseudo data generation unit
117 Abnormality detection model learning unit
121 Abnormality detection unit
122 Abnormality detection result output unit
1000 Drive device
1001 Recording medium
1002 Auxiliary storage device
1003 Memory device
1004 CPU
1005 Interface device
1006 Display device
1007 Input device

1. A learning device comprising:
a pseudo data generation determination unit, including one or more processors, configured to determine whether generation of pseudo data is needed to learn an abnormality detection model on a basis of a plurality of data having category information;
a pseudo data generation unit, including one or more processors, configured to generate pseudo data of a category when generation of the pseudo data of the category is determined to be needed by the pseudo data generation determination unit; and
an abnormality detection model learning unit, including one or more processors, configured to learn the abnormality detection model using the plurality of data and the pseudo data generated by the pseudo data generation unit.

2. The learning device according to claim 1, wherein
the pseudo data generation determination unit is configured to calculate a number of data for each category and determine whether generation of pseudo data is needed on a basis of a difference in the number of the data between the categories.

3. The learning device according to claim 2, wherein
the pseudo data generation unit is configured to generate pseudo data of a category for which generation of the pseudo data is determined to be needed to reduce the difference.

4. The learning device according to claim 1, further comprising:
a pseudo data generation model learning unit, including one or more processors, configured to learn a generation model capable of generating data of a specified category.

5. The learning device according to claim 1, further comprising:
an abnormality detection unit, including one or more processors, configured to input data of an abnormality detection target to the abnormality detection model learned by the abnormality detection model learning unit in the learning device and perform abnormality detection on a basis of output data from the abnormality detection model.

6. A learning method performed by a learning device, the learning method comprising:
determining whether generation of pseudo data is needed to learn an abnormality detection model on a basis of a plurality of data having category information;
generating pseudo data of a category when generation of the pseudo data of the category is determined to be needed; and
learning the abnormality detection model using the plurality of data and the pseudo data.

7. The learning method according to claim 6, further comprising:
inputting data of an abnormality detection target to the abnormality detection model;
performing abnormality detection on a basis of output data from the abnormality detection model; and
outputting a result of the abnormality detection.

8. The learning method according to claim 6, further comprising:
calculating a number of data for each category; and
determining whether generation of pseudo data is needed on a basis of a difference in the number of the data between the categories.

9. The learning method according claim 8, further comprising:
generating pseudo data of a category for which generation of the pseudo data is determined to be needed to reduce the difference.

10. The learning method according to claim 6, further comprising:
learning a generation model capable of generating data of a specified category.

11. A non-transitory computer readable medium storing one or more instructions causing a computer to execute:
determining whether generation of pseudo data is needed to learn an abnormality detection model on a basis of a plurality of data having category information;
generating pseudo data of a category when generation of the pseudo data of the category is determined to be needed; and
learning the abnormality detection model using the plurality of data and the pseudo data.

12. The non-transitory computer readable medium according to claim 11, further comprising:
inputting data of an abnormality detection target to the abnormality detection model;
performing abnormality detection on a basis of output data from the abnormality detection model; and
outputting a result of the abnormality detection.

13. The non-transitory computer readable medium according to claim 12, further comprising:
calculating a number of data for each category; and
determining whether generation of pseudo data is needed on a basis of a difference in the number of the data between the categories.

14. The non-transitory computer readable medium according to claim 13, further comprising:
generating pseudo data of a category for which generation of the pseudo data is determined to be needed to reduce the difference.

15. The non-transitory computer readable medium according to claim 12, further comprising:
learning a generation model capable of generating data of a specified category.
